(19) United States
(12) Patent Application Publication
(10) Pub. No.: US 2014/0365849 A1
(43) Pub. Date: Dec. 11, 2014

(54) Time-Lapse Summary Social Network

(71) Applicant: Nizam Ishmael, Fort Worth, TX (US)

(72) Inventor: Nizam Ishmael, Fort Worth, TX (US)

(21) Appl. No.: 13/910,910

(22) Filed: Jun. 5, 2013

(51) Int. Cl. G06F 17/21; G06F 17/30; G06F 17/22; H04L 12/58

(52) U.S. Cl. CPC G06F 17/212; H04L 51/32; G06F 17/3002; G06F 17/2247
USPC 715/202

(57) ABSTRACT

Computer-based systems including detailed computerized user information and other graphics capabilities may be employed to combine the provided from various information and media sources into an integrated report. Computer generated graphics are often composited with past, live, or forecast information, image frames, video clips and the integrated report to provide a complete presentation to a viewer as part of a time-lapse images and/or videos and/or information presentation.

What is desired is a system and method for dynamically composting past, present and forecast time-lapse images and/or videos and/or information with social networking information in a dynamic time synchronized graphical presentation throughout the time frame represented by the time-lapse presentation to form a dynamic combined synchronized graphical information composited with time-lapse images and/or videos and/or information presentation where the graphical or text information can be anywhere in the 4D light field.

### TECHNICAL FIELD

The present invention pertains generally to information in a social networking website and to the system and method of preparing the information regarding past, present and forecast information in combination with time-lapse images and/or videos and/or information presentation.

### BACKGROUND INFORMATION

Computer-based systems including detailed computerized user information and other graphics capabilities may be employed to combine the provided from various information and media sources into an integrated report. Computer generated graphics are often combined with past, live, or forecast information, image frames, video clips and the integrated report to provide a complete presentation to a viewer as part of a time-lapse images and/or videos and/or information presentation.

What is desired is a system and method for dynamically combining past, present and forecast time-lapse images and/or videos and/or information with social networking information in a dynamic time synchronized graphical presentation throughout the time frame represented by the time-lapse presentation to form a dynamic combined synchronized graphical information composited with time-lapse images and/or videos and/or information presentation where the graphical or text information can be anywhere in the 4D light field.

### SUMMARY

Computer-based systems including detailed computerized data and other graphics capabilities may be employed to combine the dynamic information provided from various sources into an integrated report. Computer generated graphics are often combined with live or recorded images and/or video clips and/or information to provide a complete presentation to a viewer as part of a time-lapse images and/or videos and/or information presentation.

What is desired is a system and method for dynamically combining time-lapse images and/or videos and/or information of past, present and forecast social networking data with a dynamic time synchronized graphical presentation throughout the time frame represented by the time-lapse images and/or videos to form a dynamic combined synchronized graphical information with time-lapse images and/or videos and/or information presentation.

The dynamic graphical information that is overlaid onto the time-lapse images and/or videos can be set anywhere in the 4D light field, i.e., the dynamic combined graphical information composited with time-lapse images and/or videos and/or information presentation will have to be refocused to see some of the graphical information or the graphical information can be set so that it is always in focus when the 4D light field time-lapse images and/or videos and/or information presentation is refocused by the end user.

The present invention provides a system and method for combining a time-lapse images and/or videos and/or information with time synchronized social networking information and other time-based related information anywhere in the 4D light field of the image frames and/or videos. For example, the present invention may be employed to produce a dynamic time-lapse images and/or videos and/or information presentation including integrated time-lapse images and/or videos with social networking information in combination with a time-synchronized dynamic graphical presentation of social networking information such as family updates, relationship updates, friend updates, image updates, interest updates, job updates, geotagging, etc. In accordance with the present invention, a time-lapse images and/or videos and/or information sequence of data and/or media in a social networking environment may be recorded simultaneously with information in a time-synchronized manner, to facilitate generation of a dynamic time-synchronized graphical information composited with time-lapse images and/or videos and/or information presentation with embedded past, present, and forecast social networking information. The system may also include a forecast model capability to generate forecast information or may be adapted to receive such forecast information from a separate modeling system. The production system may be programmed so as to generate a dynamic graphical information presentation from the recorded past or live information or from the forecast information.

It would be advantageous to provide a medium or website to display this dynamic combined graphical information composited with time-lapse images and/or videos and/or information presentation where the graphical information can be anywhere in the 4D light field.

It would also be advantageous to provide tools to gather the user information.

The invention will allow the automatic updating of the images and/or videos and/or information in the dynamic combined graphical information composited with time-lapse images and/or videos and/or information presentation.

The invention will take information from a forecasting model, like a calendar, to show forecast events and combine with forecast information in the dynamic combined graphical information composited with time-lapse images and/or videos and/or information presentation.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a production system view of an exemplary production system that may be used for generating a dynamic combined graphical information composited with time-lapse images and/or videos and/or information presentation in accordance with the present invention that is illustrated in the schematic block diagram of FIG. 1, and will be described in detail with reference thereto. The present invention will be described in detail herein with reference to the exemplary application thereof to generating a dynamic combined graphical information composited with time-lapse images and/or videos and/or information presentation, it should be understood that a system and method in accordance with the present invention may be employed to generate dynamic combined graphical information composited with time-lapse images and/or videos and/or information presentations for other similar or different subject matter.

A production system for generating a dynamic combined graphical information composited with time-lapse images and/or videos and/or information presentation in accordance with the present invention may preferably be implemented substantially in software procedures running on one or more conventional system computer processor or processors. The system processor may have associated there with conventional input device, e.g., a keyboard, mouse, touchpad, etc., for providing operator input to the processor to control the operation of the production system. One or more conventional output devices, such as monitors, printers, website, etc., may also be associated with the system processor. Conventional memory associated with the system processor is used to store the programming instructions that control operation of the processor, such as the programming instructions for implementing a method for generating a dynamic combined graphical information composited with time-lapse images and/or videos and/or information presentation in accordance present invention. Memory may also be employed to store images in image databases, videos in a video databases, and information in a information databases as will be discussed in more detail below.

Social networking information may be provided to the production system from a variety of information sources. Such sources may include, for example, status updates, wall posts, and public/private information updates, e.g., Twitter or other sources. Source of status update information provide current information for a particular local or remote location to the System, e.g., other website public/private information updates. Such information may include, e.g., past information, present information, and forecast information, etc. Such information may be provided to the production system manually, such as a manual visual observation of the user with subsequent manual inputting of information into the production system, or automatically. A conventional automatic input system may be employed to provide information automatically to the production system. Wall posts may include text information provided by online friends, and/or information from other sources, which may be updated more rapidly, but includes less or more detailed user information, than social networking status updates about the user or friends. Public/private information updates may provide text and/or imagery and/or video to the production system. Data transfer formats for receiving information status updates, wall posts, and public/private information updates, by the production system may be obtained from websites providing automatic status updates or from the providers of public/private information updates and wall posts, and/or from the providers wall posts, and public/private sources of information. Information received by the production system from the various user and friend information sources, wall posts, public/private information updates, and websites may be stored by the system processor for use in accordance with the present invention in the user information database portion of memory associated with the system processor.

The information sources, status updates, wall posts, and public/private information updates provide information on past and present information to the production system. The system processor may also implement a forecast model, for generating forecast images and/or videos and/or information. Alternatively, forecast model information may be provided to the production system from an independent forecasting model system. An exemplary forecasting model that may be employed to generate forecast information is the calendar. As will be described in more detail below, forecast information may also be provided to the production system manually, e.g., by employing the system input device to enter forecast information to the production system. Forecast information of any form may be stored in the user information database portion of memory for use in accordance with the present invention.

In accordance with the present invention the production system may employ a conventional camera to obtain conventional images and/or videos. For example, a production system in accordance with the present invention generating a dynamic combined graphical information composited with time-lapse images and/or videos and/or information presentation, the camera may be positioned to take images and/or videos. The camera may preferably take digital images and/or video that may be stored in a digital storage device for images and/or videos storage, e.g., memory. The camera may take analog images and/or video that may be stored in conventional analog image and/or video storage formats, e.g., film or videotape. In the latter case, the analog video taken by the camera and stored on video tape storage preferably, at some point converted into a digital format, in a conventional manner, to facilitate the videos by the system processor for generating combined graphical information composited with time-lapse images and/or videos and/or information presentation in accordance with the present invention.

Operation of the video camera is preferably under control of the system processor. For example, the system processor may control the rate at which individually spaced image frames are taken by the camera, thereby to generate a time-lapse images and/or videos.

The system processor may also be provided with a video database of pre-recorded videos for use by the production system. Such a video database of pre-recorded videos of user-selected items that may be used in generating a dynamic combined graphical information composited with time-lapse images and/or videos and/or information presentation of forecast information in accordance with the present invention, as will be described in more detail below.

The system processor preferably incorporates a real-time system clock function, which may be implemented in a conventional manner. The real-time system clock function may be employed by the processor to time stamp information received from the information sources, status updates, wall posts, user profile, and public/private information updates and then stored in the user information database by the system processor. The real-time system clock function may also be employed to time stamp videos obtained by the production system via the video camera. Thus, the real-time system clock function facilitates time frame synchronization of recorded information with time-lapse images and/or videos and/or information sequences. The real-time system clock function is also employed for the generation of a time-lapse time and date display as dynamic combined graphical information embedded on the time-lapse images and/or videos and/or information presentation in accordance with the present invention, as will be discussed in more detail below.

The production system may preferably be coupled to a conventional television broadcast system. A dynamic combined graphical information composited with time-lapse images and/or videos and/or information presentation generated by the production system in accordance with the present invention may, therefore, be provided directly to a broadcast system for broadcast, e.g., as part of an online time-lapse images and/or videos and/or information presentation. Alternatively, a dynamic combined graphical information composited with time-lapse images and/or videos and/or information presentation generated by the production system in accordance with the present invention may be stored by the production system, either internally or externally in any known analog or digital format, and/or displayed or transmitted in any other conventional format over any conventional medium, e.g. Ethernet, Internet, Wi-Fi.

FIG. 2 is a time-lapse images and/or videos and/or information presentation view of an a single frame of an exemplary dynamic combined graphical information composited with time-lapse images and/or videos and/or information presentation in accordance with the present invention is illustrated in, and will be described with reference to, FIG. 2. The exemplary dynamic combined graphical information composited with time-lapse images and/or videos and/or information presentation includes an image frame background that is comprised of time-lapse image frames, e.g., images of the users. In accordance with the present invention, a dynamic graphical information presentation, e.g., dynamic graphical information is overlaid onto the time-lapse image frame background to form the dynamic combined graphical information composited with time-lapse images and/or videos and/or information presentation. The dynamic graphical information that is overlaid onto the time-lapse images and/or videos and/or information sequences can be set anywhere in the 4D light field, e.g., the dynamic combined graphical information composited with time-lapse images and/or videos and/or information presentation will have to be refocused to see some of the graphical information or the graphical information can be set so that it is always in focus when the 4D light field time-lapse images and/or videos and/or information presentation is refocused by the end user. For example, the exemplary dynamic graphical information overlaid on the time-lapse images and/or videos and/or information presentation illustrated in FIG. 2 includes dynamic status updates, wall posts, biometric information, and a number of social networking friends.

Dynamic graphical status updates may take the form of formatted text or a graphically represented mood display. The graphically represented mood indicator in the box may be dynamically animated to move left and right corresponding to changes in mood for the time frame represented by the dynamic combined graphical information composited with time-lapse images and/or videos and/or information presentation. The dynamic graphical information status updates may include a mood indicator or other indications, for example, the high and/or low moods reached during the time frame represented in the dynamic combined graphical information composited with time-lapse images and/or videos and/or information presentation. Such a mood indicator may be added dynamically to the graphical mood presentation, e.g., at the point in time during presentation when the mood indicated by the mood indicator reaches the high and/or low mood mark to be indicated. Of course, changing moods throughout a time frame of interest may be indicated in a dynamic graphical information format that is different from the mood illustrated in FIG. 2. For example, a dynamic representation of a dial type mood meter be included in the dynamic graphical information presentation. As illustrated in FIG. 2, a dynamic graphical presentation of wall posts may take the form of a graphic represented by scrolling text or similar text display device. For example, in such a dynamic graphical information composited with time-lapse images and/or videos and/or information presentation the number of wall posts in the graphically represented scrolling text may increase dynamically through the duration of the time-lapse presentation indicate dynamically accumulating wall posts throughout the time frame represented by the dynamic combined graphical information composited with time-lapse images and/or videos and/or information presentation.

As illustrated in FIG. 2, the number of social networking friends during the time frame represented by the dynamic combined graphical information composited with time-lapse images and/or videos and/or information presentation may be indicated by a number. The direction pointed to by a graphical indicator for the number of friends next to displayed number of social networking friends may be updated dynamically throughout the dynamic combined graphical information composited with time-lapse images and/or videos and/or information presentation to indicate changing number of friends during the time frame represented by the time-lapse presentation.

Of course, it should be understood, that not all of the user information presented in the exemplary dynamic combined graphical information composited with time-lapse images and/or videos and/or information presentation of FIG. 2 need be included in such a presentation in accordance with the present invention. It should also be understood that information other than that shown in the exemplary dynamic combined graphical information composited with time-lapse images and/or videos and/or information presentation of FIG. 2, e.g., avatar update, geotagging, may be included in such a presentation in accordance with the present invention. Also, information may be presented in similar or entirely different formats from the presentation illustrated by example in FIG. 2.

A time-lapse date and/or time display is preferably overlaid on the time-lapse images and/or videos and/or information presentation background in accordance with the present invention. The dynamic graphical time-lapse date and/or time display presents a viewer in a dynamic combined graphical date and/or time information composited with time-lapse images and/or videos and/or information presentation incorporating such a display with an indication of the time of day that is being represented at any one point in time represented by the dynamic combined graphical information composited with time-lapse images and/or videos and/or information presentation. Thus, the dynamic graphical time-lapse date and/or time display provides real-time temporal context to a viewer of the dynamic combined graphical information composited with time-lapse images and/or videos and/or information presentation. Although illustrated in FIG. 2 as a dynamic graphically represented digital time and date display, it should be understood that a time-lapse time and date display to be included in dynamic combined graphical information composited with time-lapse images and/or videos and/or information presentation in accordance with the presented in any appropriate format for indicating real-time in the dynamic combined graphical information composited with time-lapse images and/or videos and/or information presentation.

FIG. 3 is a flowchart diagram view of an exemplary flowchart diagram for generating a dynamic combined graphical information composited with time-lapse images and/or videos and/or information presentation of past, present, and forecast information as illustrated in, and will be reference to, the flowchart diagram of FIG. 3. It should be understood that the steps of the flowchart diagram illustrated in the flowchart diagram of FIG. 3 might be performed in a different order from that presented in FIG. 3 and discussed below. A programmer skilled in the art will be able to implement many of the functions performed by the method to be discussed below in a conventional computer processor system. Such computer implemented functionality may include graphical or other user interfaces, e.g., presented on the system processor output device, which allow an operator of the production system to interact with the software program, e.g., input device, to make necessary user selections and otherwise control operation of the process of generating a dynamic combined graphical information composited with time-lapse images and/or videos and/or information presentation in accordance with the present invention.

The first two steps of the FIG. 3 flowchart diagram for generating a dynamic combined graphical information composited with time-lapse images and/or videos and/or information presentation of past, present, and forecast information in accordance with the present invention are to obtain a time-lapse images and/or videos and/or information sequences for a time frame of interest, and to record user information for the same time frame. As discussed above, the step “Record Time-lapse Video” 62 for time-lapse image frames and/or videos for a time frame of interest may be performed by a system processor that controls a video camera to take, e.g., a time-lapse image frames and/or videos of user selected items over a selected time frame. The system processor may control operation of the camera to record image frames at spaced apart time intervals, such that when the image frames are played back at a normal speed, a sped-up time-lapse image frames and/or videos are provided. To prevent an abrupt start and stop to the time-lapse images and/or video and/or information sequence when replayed, the system processor may control the camera to obtain a time-lapse image frames and/or videos, which when played back, accelerates gradually from normal speed at the beginning of the presentation and decelerates gradually to normal speed at the end of the presentation. This may be achieved by controlling the camera to record higher video frame rate more near the beginning and ends of the time-lapse images and/or video and/or information sequence, while gradually increasing the time between the recording of video clips as the time from the two ends of the image frames and/or videos increases, such that a sped-up time lapse image frames and/or video and/or information presentation is provided during the middle of the sequence, with image frames and/or videos and/or information recorded at a more normal speed at the beginning and end. The image frames forming the time-lapse images and/or videos and/or information sequences may be time-stamped, e.g., employing the processor real-time system clock function as each frame or a selected subset of frames are taken. The time-lapse image frames and/or videos that are recorded in step “Record Time-lapse Video” 62 may be saved in conventional digital or analog video storage medium, e.g., memory, image database 16, video database 17, as discussed above.

Information is recorded from one or more information sources such as status updates, wall posts, geotagging, biometric, and public/private information updates, at step “Record User Information” 64 over the same time frame for which a time-lapse images and/or videos are obtained at step “Record Time-lapse Video” 62. For example, each time an image frame, or a selected subset of image frames, is taken by the video camera under control of the system processor, the system processor may also record a set of information from one or more of the information sources such as status updates, wall posts, and public/private information updates. Such information, e.g., status updates, wall posts, number of friends, etc., may be stored by the system processor in the user information database 18 portion of memory associated with the processor. Each time information is obtained and recorded by the production system from information sources such as status updates, wall posts, and public/private information updates, the real-time system clock function implemented in the system processor is queried and the information obtained is time stamped accordingly. Alternatively, the system processor may obtain and record time stamped information for the time frame over which the time-lapse image frames and/or videos are obtained at time intervals, which do not necessarily correspond with the time frames that the image frames and/or videos forming the time-lapse image frames and/or videos are obtained.

Images and/or videos and/or information can be selected as dynamic. The user will select the images and/or videos and/or information and then select the time intervals for the updates. Only the selected dynamic images and/or videos and/or information will be updated when the time intervals are met.

Preferably in a dynamic combined graphical information and time-lapse images and/or videos and/or information presentation in accordance with the present invention, the dynamic combined graphical information composited with time-lapse images and/or videos and/or information presentation are time frame synchronized in step “Scale Video, Image, and User Information” 66. In other words, for any given point in time during the dynamic combined graphical information composited with time-lapse images and/or videos and/or information presentation the information presented at that time in the presentation should correspond to the information obtained at the same, or substantially the same, point in real-time as the corresponding images and/or video frames were taken. Such time frame synchronization may be obtained by scaling at step “Scale Video, Image, and User Information” 66 the time-lapse images and/or videos obtained at step “Record Time-lapse Video” 62 and the information obtained at step “Record User Information” 64 to cover the same time frame, including any acceleration or deceleration in the time-lapse image frames and/or videos and/or information to smooth the time-lapse image frames and/or videos and/or information presentation as described above. Such scaling is performed automatically when information is obtained at step “Record User Information” 64 each time a corresponding frame of the time-lapse images and/or videos are obtained. If such simultaneous time synchronization of the images and/or videos and/or information is not performed, scaling of the time-lapse images and/or videos and/or information may be performed using time stamps associated with the recorded time-lapse images and/or videos and/or information obtained over the same time frame. For example, for each time-stamped frame, or selected subset of frames, in the time-lapse images and/or videos and/or information, the system processor may retrieve from the information database 18 the recorded information for that time, or for a nearly associated time. However, this is only possible if the time-lapse images and/or videos and/or information obtained over a selected time frame are time stamped using the same real-time system clock function, or using separate time-synchronized, real-time clocks.

A dynamic graphical information presentation is generated at step “Generate User Graphics” 68 from the selected and scaled information. As described above, the dynamic graphical information presentation is a dynamic animated graphical presentation of changing user-selected items over a selected time frame. Such a dynamic graphical information presentation may be generated in a conventional manner using conventional computer graphics generation techniques. The dynamic graphical information presentation generated at step “Generate User Graphics” 68 should be generated in such a way as to maintain time synchronization between the generated dynamic graphical information presentation and the recorded time-lapse images and/or videos and/or information with which the dynamic graphical information presentation is to be composited.

The dynamic graphical information presentation is combined with the time-lapse images and/or videos to form a combined graphical information composited with time-lapse images and/or videos and/or information presentation in accordance with the present invention at step “Combine Graphics with Video” 70 as discussed above, the dynamic graphical information presentation may be combined with the time-lapse images and/or videos by overlaying the dynamic graphical information presentation over a background of the time-lapse images and/or videos. This may be accomplished in a conventional manner for each frame in the combined graphical information composited with time-lapse images and/or video presentation, e.g., using conventional compositing techniques for overlaying and/or replacing selected image elements of the time-lapse images and/or videos with the dynamic graphical information presentation.

The resulting combined graphical information composited with time-lapse images and/or video presentation generated at step “Combine Graphics with Video” 70 may be displayed as part of an online presentation at step “Display Combined Video, Image, and User Information” 72. Before presenting the dynamic combined graphical information composited with time-lapse images and/or video presentation as part of a broadcast report, the dynamic combined graphical information composited with time-lapse images and/or video and/or information presentation may preferably be previewed by an operator of the production system on a system output device, e.g., a system monitor. Additionally, or alternatively, the dynamic combined graphical information composited with time-lapse images and/or videos and/or information presentation generated in accordance with the present invention may be saved, e.g., in a conventional manner, in digital or analog form, for future playback and/or transmitted to viewers over any known conventional media channel, e.g., website.

If only dynamic information was updated the user may select to approve the new display combined images and/or videos and/or information before it is saved to a medium or displayed.

At step “Update Selected Dynamic Information, Video and Image” 94, images and/or videos selected as being dynamic will be updated at the selected interval at step “Record Time-lapse Video” 62 and/or step “Record User Information” 64.

FIG. 4 is a flowchart diagram view of an exemplary method for generating dynamic combined graphical information composited with time-lapse images and/or videos and/or information presentation of forecast information in accordance with the present invention and will be described in detail with reference thereto. As discussed above with reference to the flowchart diagram of FIG. 3, the steps presented in the flowchart diagram of FIG. 4 may be performed in a different order from that presented therein, and many of the steps may be implemented for automatic operation in a computer system.

Information displayed in a dynamic combined graphical information composited with time-lapse images and/or videos and/or information presentation of selected dynamic, past, present, forecast information in accordance with the present invention is based on information for a selected time frame of interest defined by an operator at step “Define User Information and Time Frame” 82. The operator must select the time frame of interest for the presentation as well as the static and dynamic information to be represented in the presentation. Forecast information may be obtained from a variety of sources, including forecast information that was obtained from sources external to the production system, and recorded in the user information database 18, forecast information entered manually into the production system by an end user, e.g., using the system input devices, and or forecast information that is generated internal to the system, e.g., using a information forecast model. An operator may also wish to select a particular presentation format for the dynamic combined graphical information composited with time-lapse images and/or videos and/or information presentation to be generated, e.g., smooth acceleration and deceleration of the presentation at the beginning and end, as discussed above.

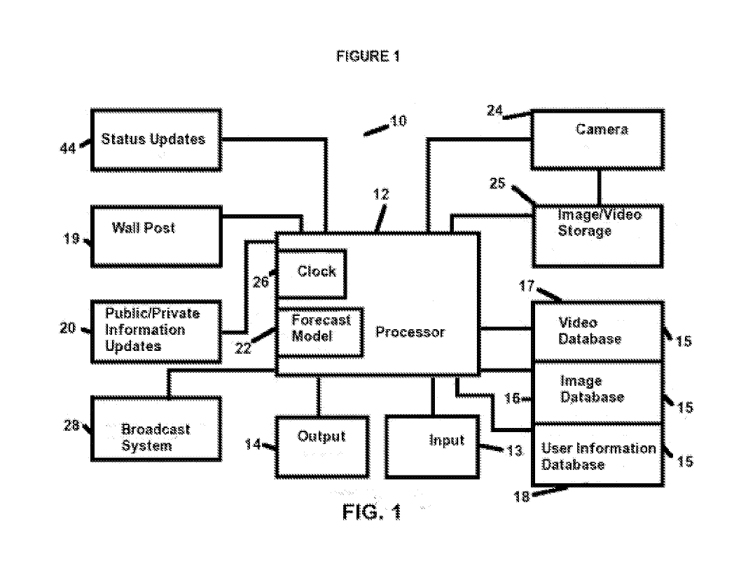

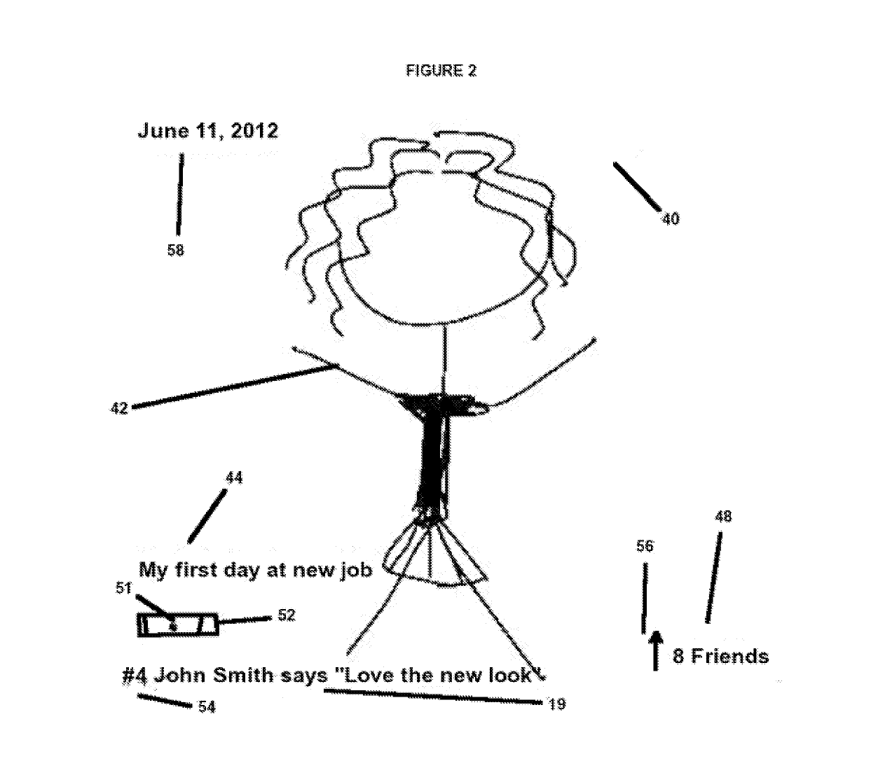

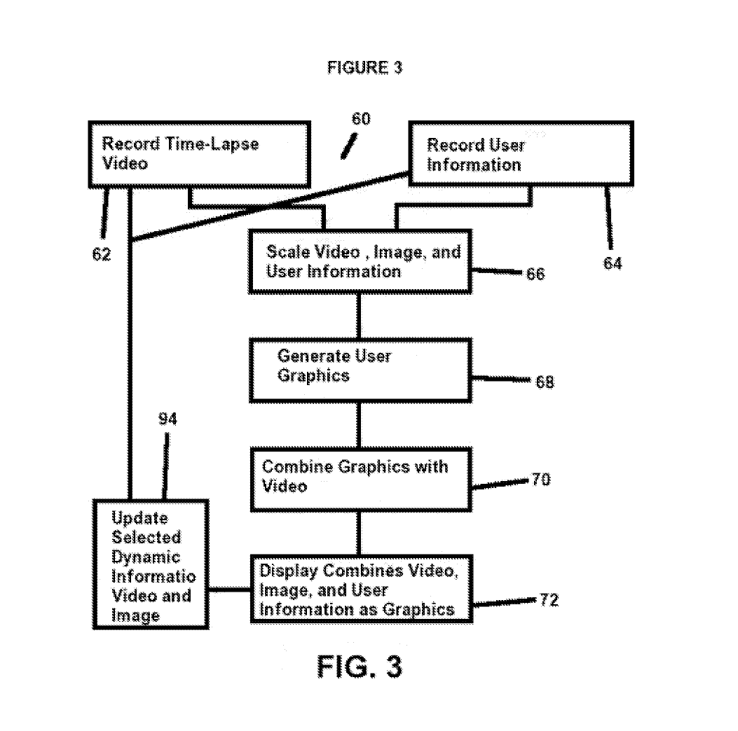

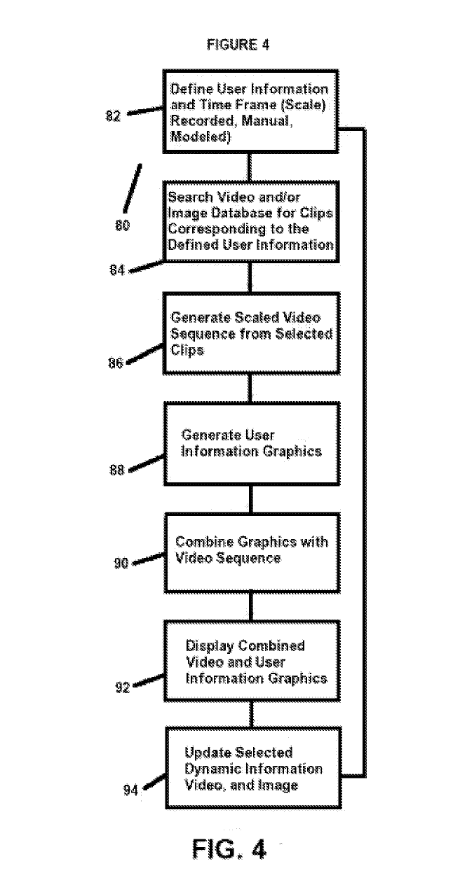

After defining the forecast information to be included in the dynamic combined graphical information composited with time-lapse images and/or videos and/or information presentation appropriate image and/or videos corresponding to the forecast information must be obtained. Preferably a plurality of pre-recorded images and/or videos for various different information and times of day may be stored in the production system, e.g., image database 16, video database 17, user information database 18, and organized for easy retrieval via step “Search Video and/or Image Database for Clips Corresponding to the Defined User Information” 84. Such stored images and/or videos may be labeled with appropriate descriptors before being saved so as to allow for easy retrieval. Such descriptors should correspond to the types of forecast information that are to be included in the dynamic combined graphical information composited with time-lapse images and/or video and/or information presentation. For example, typical image and/or video descriptors may be: January 2012, February 2012, March 2012; trip to New York, trip to Miami, trip to Los Angeles; engagement party, wedding day, honeymoon; etc. Based on these descriptors, an operator of the system 10 (FIG. 1) may easily retrieve pre-recorded images and/or videos corresponding to the forecast information to be included in the dynamic combined graphical information composited with time-lapse images and/or videos and/or information presentation. Alternatively, the production system may be programmed to retrieve automatically, via the image database 16 or video database 17, appropriate image and/or videos corresponding to the forecast information to be included in the dynamic combined graphical information composited with time-lapse images and/or videos and/or information presentation.

At step “Generate Scaled Video Sequence from Selected Clips” 86, the selected images and/or videos are combined and scaled to form integrated images and/or videos for the time frame and scale previously indicated by the operator at step “Define User Information and Time Frame” 82. This may require combining several stored images and/or videos clips in an appropriate order corresponding to changing information represented in the forecast information to be included in the dynamic combined graphical information composited with time-lapse images and/or videos and/or information presentation.

At step “Generate User Information Graphics,” 88 a computer generated dynamic graphical information presentation is generated from the past, present and forecast information for the time frame to be represented in the dynamic combined graphical information composited with time-lapse images and/or videos and/or information presentation in the manner described above. The resulting dynamic graphical information presentation and the time-scaled images and/or videos are combined in the manner described above. “Combine Graphics with Video Sequence” 90, and presented, e.g., as part of televised broadcasts or website, in the manner described above, at step “Display Combined Video and Information Graphics” 92.

When only dynamic information needs to be updated, the user may select to approve the new combined images and/or videos and/or information before it is saved to a medium or displayed.

At step “Update Selected Dynamic Information, Video and Image” 94, the images and/or videos and/or information selected as being dynamic will be updated at the selected interval at step “Define User Information and Time Frame” 82.

For purposes of clarity and brevity, like elements and components will bear the same designations and numbering throughout the Figures.

### DETAILED DESCRIPTION OF THE PREFERRED EMBODIMENTS

FIG. 1 is a view of an exemplary production system 10 that may be used for generating a dynamic combined graphical information composited with time-lapse images and/or videos and/or information presentation 40 (FIG. 2) in accordance with the present invention is illustrated in the schematic block diagram of FIG. 1, and will be described in detail with reference thereto. Although the present invention will be described in detail herein with reference to the exemplary application thereof to generating a dynamic combined graphical information composited with time-lapse images and/or videos and/or information presentation 40, it should be understood that a system and method in accordance with the present invention may be employed to generate dynamic combined graphical information composited with time-lapse images and/or videos and/or information presentations for other similar or different subject matter.

A production system 10 for generating a dynamic combined graphical information composited with time-lapse images and/or videos and/or information presentation 40 in accordance with the present invention may preferably be implemented substantially in software procedures running on one or more conventional system computer processor 12 or processors. The system processor 12 may have associated there with conventional input device 13, e.g., a keyboard, mouse, etc., for providing operator input to the processor 12 to control the operation of the production system 10. One or more conventional output device 14, such as monitors, printers, etc., may also be associated with the system processor 12. Conventional memory 15 associated with the system processor 12 is used to store the programming instructions that control operation of the processor 12, such as the programming instructions for implementing a method for generating a dynamic combined graphical information composited with time-lapse images and/or videos and/or information presentation 80 in accordance with the present invention. Memory 15 may also be employed to store a image database 16, a video database 17, and a user information database 18, as will be discussed in more detail below.

Social networking information may be provided to the production system 10 from a variety of information sources. Such sources may include, e.g., status updates 44, wall posts 19, public/private information updates 20, and twitter sources. Status updates 44 sources of information, e.g., provide current information for a particular local or remote location to the system. Such information may include, for example, current information, previous information, and forecast information, etc. Such information may be provided to the production system manually, such as a manual visual observation of the user with subsequent manual inputting of information into the production system 10, or automatically. A conventional automatic input system may be employed to provide information automatically to the production system 10. Wall posts 19 may include wall post information provided by online friends, information from other sources, which may be updated more rapidly, but which includes less or more detailed information than social networking status updates 44, e.g., bio metric information and geotagging information. Public/private information updates 20 may provide text and/or imagery and/or video to the production system 10. Data transfer formats for receiving information status updates 44, wall posts 19, and public/private information updates 20, by the production system may be obtained from websites providing automatic status updates 44 or from the providers of public/private information updates 20 and wall posts 19, and/or from the providers wall posts, and/or public/private sources of information. Information received by the production system 10 from the various user and friend information sources, wall posts 19, and public/private information updates 20, may be stored by the system processor 12 for use in accordance with the present invention in the user information database 18 portion of memory 15 associated with the system processor 12.

The information sources status updates 44, wall posts, and public/private information updates 20 provide information on past, present and forecast information to the production system 10. The system processor 12 may also implement a forecast model 22, for generating forecast information. Alternatively, forecast model 22 information may be provided to the production system 10 from an independent information forecasting model system. An exemplary information forecasting model may be employed to generate forecast information is the calendar. As will be described in more detail below, forecast information may also be provided to the production system 10 manually, e.g., by employing the system input device 13 to enter forecast information to the production system 10. Forecast information of any form may be stored in the user information database 18 portion of memory 15 for use in accordance with the present invention.

In accordance with the present invention the production system 10 may employ a conventional camera 24 to obtain conventional images and/or videos. For example, a production system 10 in accordance with the present invention generating a dynamic combined graphical information composited with time-lapse images and/or videos and/or information presentation 40, the camera 24 may be positioned to take images and/or videos. The image and/or video camera 24 may preferably take digital images and/or videos that may be stored in a digital storage device for image/video storage 25, e.g., memory 15. Alternatively, the camera 24 may take analog images and/or videos to be stored in conventional analog image and/or video storage formats, e.g., film, videotape. The analog images and/or video taken by the camera 24 and stored in image/video storage 25 preferably, at some point converted into a digital format, in a conventional manner, to facilitate the images and/or videos by the system processor 12 for generating a dynamic combined graphical information composited with time-lapse images and/or videos and/or information presentation 40 in accordance with the present invention.

Operation of the camera 24 is preferably under control of the system processor 12. For example, the system processor 12 may control the rate at which individual spaced image frames are taken by the image and/or video camera 24, thereby generating time-lapse images and/or videos. The system processor 12 may also be provided with a video database 17 and/or image database of pre-recorded images and/or videos for use by the production system 10. Such a video database 17 and/or image database 16 of pre-recorded images and/or videos of user selected items that may be used generating a dynamic combined graphical information composited with time-lapse images and/or videos and/or information presentation 40 of forecast information in accordance with the present invention, will be described in more detail below.

The system processor 12 preferably incorporates a system clock 26 function, which may be implemented in a conventional manner. The real-time system clock 26 function may be employed by the processor 12 to time stamp information received from the information sources, e.g., status updates 44, wall posts 19, and public/private information updates 20 and stored in the user information database 18 by the system processor 12. The real-time system clock 26 function may also be employed to time stamp images and/or videos obtained by the production system 10 via the camera 24. Thus, the real-time system clock 26 function facilitates time frame synchronization of recorded information with time-lapse images and/or videos. The system clock 26 function is also employed for the generation of a time-lapse time and date display 58 on a dynamic combined graphical information composited with time-lapse images and/or video and/or information presentation 40 in accordance with the present invention, as will be discussed in more detail below.

The production system 10 may preferably be coupled to a broadcast system 28. A dynamic combined graphical information composited with time-lapse images and/or videos and/or information presentation 40 generated by the production system in accordance with the present invention may be provided directly to a broadcast system 28 for broadcast, e.g., as part of an online time-lapse images and/or videos and/or information presentation. Alternatively, a dynamic combined graphical information composited with time-lapse images and/or videos and/or information presentation 40 generated by the production system 10 in accordance with the present invention may be stored by the production system 10, either internal or external in any known analog or digital format and/or displayed or transmitted in any other conventional format over any conventional medium.

FIG. 2 is a time-lapse images and/or videos and/or information presentation view of a single frame of an exemplary dynamic combined graphical information composited with time-lapse images and/or videos and/or information presentation 40 in accordance with the present invention illustrated in, and will be described with reference to, FIG. 2. The exemplary combined graphical information composited with time-lapse images and/or videos and/or information presentation 40 includes images and/or videos background 42 that is comprised of a time-lapse images and/or videos and/or information sequence, e.g., an image of the user. In accordance with the present invention, a dynamic graphical information presentation, e.g., dynamic graphical information is overlaid onto the time-lapse images and/or videos and/or information presentation background 42 to form the combined graphical information composited with time-lapse images and/or videos and/or information presentation 40. The dynamic graphical user information that is overlaid onto the time-lapse images and/or videos and/or information presentation can be set anywhere in the 4D light field, e.g., the dynamic combined graphical information composited with time-lapse images and/or videos and/or information presentation 40 will have to be refocused to see some of the dynamic graphical information or the dynamic graphical information can be set so that it is always in focus when the 4D light field time-lapse images and/or videos and/or information presentation is refocused by the end user. For example, the dynamic graphical information overlaid on the time-lapse images and/or videos and/or information background 42 of the exemplary dynamic combined graphical information composited with time-lapse images and/or videos and/or information presentation 40 illustrated in FIG. 2 includes dynamic status updates 44, wall posts 19, and number of social networking friends 48. Dynamic graphical status updates may, for example take the form of formatted text or a graphically represented mood display 52. The graphically represented mood indicator 51 in the box may be dynamically animated to move left and right corresponding to changes in mood for the time frame represented by the dynamic combined graphical information composited with time-lapse images and/or videos and/or information presentation 40. The dynamic graphical information status updates 44 may include a mood indicator 51 or other indication, e.g., the high and/or low moods reached during the time frame represented in the dynamic combined graphical information composited with time-lapse images and/or videos and/or information presentation 40. Such a mood indicator 51 may preferably be added dynamically to the graphical mood presentation, e.g., at the point in time during the presentation when the mood indicated by the mood indicator 51 reaches the high and/or low mood mark to be indicated. Of course, changing moods throughout a time frame of interest may be indicated in a dynamic graphical information format that is different from the mood illustrated in FIG. 2. For example, a dynamic representation of a dial type mood meter may be included in the dynamic graphical information presentation.

As illustrated in FIG. 2, a dynamic graphical presentation of wall post 19 may take the form of, e.g., a graphic represented by scrolling text or similar text display device. For such dynamic graphical information, e.g., the number of wall post 54 in the graphically represented scrolling text may increase dynamically through the duration of the dynamic combined graphical information composited with time-lapse images and/or videos and/or information presentation 40, thereby to indicate dynamically accumulating wall post 19 throughout the time frame represented by the dynamic combined graphical information composited with time-lapse images and/or videos and/or information presentation 40.

As illustrated in FIG. 2, number of social networking friends 48 during time frame represented by the dynamic combined graphical information composited with time-lapse images and/or videos and/or information presentation 40 may be indicated by a number. The direction pointed to by a graphical indicator for number of friends 56 next to displayed number of social networking friends 48 may be updated dynamically throughout the dynamic combined graphical information composited with time-lapse images and/or videos and/or information presentation 40 to indicate changing number of friends during the time frame represented by the time-lapse images and/or videos and/or information presentation.

Of course, it should be understood, that not all the user information presented in the exemplary dynamic combined graphical information composited with time-lapse images and/or videos and/or information presentation 40 of FIG. 2 need be included in such a presentation in accordance with the present invention. It should also be understood that information other than that shown in the exemplary dynamic combined graphical information composited with time-lapse images and/or videos and/or information presentation 40 of FIG. 2, e.g., avatar updates, etc., may be included in such a presentation in accordance with the present invention. Also, information may be presented in similar or entirely different formats from the dynamic graphical information presentation illustrated by example in FIG. 2.

A time-lapse time and date display 58 is preferably overlaid on the time-lapse images and/or videos and/or information background 42 of a dynamic combined graphical information composited with time-lapse images and/or videos and/or information presentation in accordance with the present invention. The time-lapse time and date display 58 may be generated and displayed in a conventional manner along with or as part of the dynamic graphical information presentation. The dynamic graphical time-lapse time and date display 58 presents a viewer of a dynamic combined graphical information composited with time-lapse images and/or videos and/or information presentation 40 incorporating such a display with an indication of the time of day that is being represented at any one point in time by the combined graphical information composited with time-lapse images and/or videos and/or information presentation 40. Thus, the dynamic graphical time-lapse time and date display 58 provides temporal context to a viewer of the dynamic combined graphical information composited with time-lapse images and/or videos and/or information presentation 40. Although illustrated in FIG. 2 as a dynamic graphically represented digital time and date display 58, it should be understood that a time-lapse time and date display 58 to be included in a combined graphical information composited with time-lapse images and/or videos and/or information presentation 40 in accordance with the present invention may be presented in any appropriate format for indicating real-time in the combined graphical information composited with time-lapse images and/or videos and/or information presentation 40.

FIG. 3 is a flowchart diagram view for generating a combined graphical information composited with time-lapse images and/or videos and/or information presentation of past information 60 as illustrated in, and will be described with reference to, the flowchart diagram of FIG. 3. It should be understood that the steps of the flowchart diagram illustrated in the flowchart diagram of FIG. 3 may be performed in a different order from that presented in FIG. 3 and discussed below. A programmer skilled in the art will be able to implement many of the functions performed by the method to be discussed below in a conventional computer production system 10. Such computer implemented functionality may include graphical or other user interfaces, e.g., presented on the system processor 12 output device 14, which allow an operator of the production system 10 to interact with the software program, e.g., via input device 13, to make necessary user selections and otherwise control operation of the process of generating a combined graphical information composited with time-lapse images and/or videos and/or information presentation in accordance with the present invention. The first two steps of the flowchart diagram for generating a combined graphical information composited with time-lapse images and/or videos and/or information presentation of past information 60 in accordance with the present invention are to obtain a time-lapse images and/or videos and/or information for a time frame of interest or record time-lapse video 62 and to record information for the same time frame. As discussed above, the step “Record Time-lapse Video” 62 for time-lapse images and videos for a time frame of interest may be performed by a system processor 12, which controls a camera 24 to take, e.g., a time-lapse images and/or videos of user selected items over a selected time frame. The system processor 12 may control operation of the camera 24 to record image frames at spaced apart time intervals, such that when the image frames thus obtained is played back at a normal speed, a sped up time-lapse images and/or videos and/or information are provided. To prevent an abrupt start and stop to the time-lapse images and/or videos and/or information when replayed, the system processor 12 may control the camera 24 to obtain a time-lapse images and/or videos and/or information which when played back, accelerates gradually from normal speed at the beginning of the presentation and decelerates gradually to normal speed at the end of the presentation. This may be achieved by controlling the camera 24 to record image frames more frequently near the beginning and ends of the time-lapse images and/or videos and/or information, while gradually increasing the time between the recording of image frames as the time from the two ends of the images and/or videos increases, such that a sped-up time-lapse images and/or videos presentation is provided during the middle of the sequence, with image frames recorded at a more normal speed at the beginning and end thereof. The image frames forming the time-lapse images and/or videos and/or information obtained may be time stamped, e.g., employing the processor 12 real-time system clock 26 function, as each image frame or a selected subset of image frames are taken. The time-lapse images and/or videos and/or information recorded in step “Record Time-lapse Video” 62 may be saved in conventional digital or analog video storage medium, memory 15, image database 16, video database 17, as discussed above.

Information is recorded from one or more information sources such as status updates 44, wall posts 19, and public/private information updates 20, at step “Record User Information” 64 over the same time frame for which a time-lapse images and/or videos and/or information are obtained at step “Record Time-lapse Video” 62. For example, each time an image frame, or a selected subset of image frames, are taken by the camera 24 under control of the system processor 12, the system processor 12 may also record a set of information from one or more of the information sources such as status updates 44, wall posts 19, and public/private information updates 20. Such information, e.g., status updates 44, wall posts 19, number of friends 48, etc., may be stored by the system processor 12 in the user information database 18 portion of memory 15 associated with the system processor 12. Each time information is obtained and recorded by the production system 10 from information sources such as status updates 44, wall posts 19, and public/private information updates 20, the real-time system clock 26 function implemented in the system processor 12 is queried and the information obtained is time stamped accordingly. Alternatively, the system processor 12 may obtain and record time-stamped information for the time frame over which the time-lapse images and/or videos and/or information are obtained at time intervals that do not necessarily correspond with the time frames at which image frames forming the time-lapse images and/or videos and/or information are obtained.

Images and/or videos and/or Information can be selected as dynamic. The user will select the images and/or videos and/or information and then select the time interval for the update. Only the selected dynamic images and/or videos and/or information will be updated when the time interval is met.

Preferably in a dynamic combined graphical information composited with time-lapse images and/or videos and/or information presentation 40 in accordance with the present invention, the time-lapse images and/or videos and/or information and dynamic graphical information presentation forming the dynamic combined presentation are time frame synchronized in step “Scale Video, Image, and User Information” 66. In other words, for any given point in time during the dynamic combined graphical information composited with time-lapse images and/or videos and/or information presentation 40 the information presented at that time in the dynamic combined presentation should correspond to the information obtained at the same, or substantially the same, point in real-time as the corresponding image frames were taken. Such image frame time synchronization may be obtained by scaling at step Scale Video, Image, and User Information” 66 the time-lapse images and/or videos obtained at step “Record Time-lapse Video” 62 and the information obtained at step “Record User Information” 64 to cover the same time frame, including any acceleration or deceleration in the time-lapse images and/or videos and/or information to smooth the time-lapse images and/or videos and/or information presentation as described above. Such scaling is performed automatically if information is obtained at step “Record User Information” 64 each time a corresponding image frames of the time-lapse images and/or videos and/or information is obtained. If simultaneous time synchronization of the images and/or videos and/or information is not performed, scaling of the time-lapse images and/or videos and/or information may be performed using time stamps associated with the recorded time-lapse images and/or videos and/or information obtained over the same time frame. For example, for each time stamped image frame or selected subset of image frames, in the time-lapse images and/or videos and/or information, the system processor 12 may retrieve for use from the user information database 18 the recorded information for that time, or for a nearly associated time. However, this is only possible if the time-lapse images and/or videos and/or information obtained over a selected time frame are time stamped using the same real-time system clock 26 function, or using separate but time synchronized real-time clocks.

A dynamic combined graphical information presentation is generated at step “Generate User Graphics” 68 from the selected and scaled information. As described above, the dynamic combined graphical information presentation is a dynamic animated graphical presentation of changing user-selected items over a selected time frame. Such a dynamic combined graphical information composited with time-lapse images and/or videos and/or information presentation may be generated in a conventional manner using conventional computer graphic generation techniques. The dynamic combined graphical information composited with time-lapse images and/or videos and/or information presentation generated at step “Generate User Graphics” 68 should be generated in such a way as to maintain time synchronization between the generated dynamic combined graphical information and the time-lapse and time-lapse images and/or videos and/or information presentation with which the dynamic graphical information is to be combined.

The dynamic graphical information presentation is combined with the time-lapse images and/or videos and/or information to form a combined graphical information composited with time-lapse images and/or videos and/or information presentation 40 in accordance with the present invention at step “Combine Graphics with Video” 70. As discussed above, the dynamic graphical information presentation may be combined with the time-lapse images and/or videos and/or information by overlaying the dynamic graphical information presentation over a background of the time-lapse images and/or videos and/or information. This may be accomplished in a conventional manner, e.g., for each frame in the combined graphical information composited with time-lapse images and/or videos and/or information presentation, using conventional compositing techniques for replacing selected image elements of the time-lapse images and/or videos and/or information background with the dynamic graphical information.

The resulting dynamic combined graphical information composited with time-lapse images and/or videos and/or information presentation 40 generated at step “Combine Graphics with Video” 70 may be displayed, e.g., as part of an online presentation, at step “Display Combined Video, Image, and User Information” 72. Before presenting the dynamic combined graphical information composited with time-lapse images and/or videos and/or information presentation 40 as part of a broadcast report, the dynamic combined graphical information composited with time-lapse images and/or videos and/or information presentation may preferably be previewed by an operator of the production system 10, e.g., on a system output device 14, such as a system monitor. Additionally, or alternatively, the dynamic combined graphical information composited with time-lapse images and/or videos and/or information presentation generated in accordance with the present invention may be saved in a conventional manner, in digital or analog form, for future playback, and/or transmitted to viewers over any known conventional media channel.

If only dynamic information was updated the user may select to approve the new combined time-lapse images and/or videos and/or information presentation before it is saved to a medium or displayed.

At step “Update Selected Dynamic Information, Video and Image” 94, videos and images selected as being dynamic will be updated at the selected interval at step “Recorded Time-Lapse Video” 62 and step “Record User Information” 64.

FIG. 4 is a flowchart diagram view of an exemplary method for generating a dynamic combined graphical information composited with time-lapse images and/or videos and/or information presentation 80 of forecast information in accordance with the present invention is illustrated in the flowchart diagram of FIG. 4, and will be described in detail with reference thereto. As discussed above with reference to the flowchart diagram of FIG. 3, the steps presented in the flowchart diagram of F. 4 may be performed in a different order from that presented therein, and many of the steps may be implemented for automatic operation in a computer system.

Information displayed in a dynamic combined graphical information composited with time-lapse images and/or videos and/or information presentation of selected dynamic, past, present, forecast information in accordance with the present invention is based on information for a selected time frame of interest defined by an operator at step “Define User Information and Time Frame” 82. The operator must select the time frame of interest for the presentation as well as the static and dynamic information to be represented in the presentation. Forecast or possible future information may be obtained from a variety of sources, including forecast information that was obtained externally from the production system 10, and recorded in the user information database 18, forecast information entered manually into the production system 10 by an end user, e.g., using the system input device 13, and or forecast information that are generated internally to the system, e.g., using a information forecast model 22. An operator may also wish to select a particular presentation format for the dynamic combined graphical information composited with time-lapse images and/or videos and/or information presentation 40 to be generated, e.g., smooth acceleration and deceleration of the presentation at the beginning and end thereof, as discussed above.

Having defined the forecast information to be included in the dynamic combined graphical information composited with time-lapse images and/or videos and/or information presentation appropriate image frames corresponding to the forecast information must be obtained. Preferably a plurality of pre-recorded image frames for various different information and times of day may be stored in the production system 10, e.g., in image/video storage 25, and organized for easy retrieval via step “Search Video and/or Image Database for Clips Corresponding to the Defined User Information” 84. Such stored image frames may be labeled with appropriate descriptors before being saved so as to allow for easy retrieval. Such descriptors should correspond to the type of forecast information that are to be included in a dynamic combined graphical information composited with time-lapse images and/or videos and/or information forecast presentation. For example, typical image frame descriptors may be: January 2012, February 2012, March 2012; trip to new york, trip to Miami, trip to Los Angeles; engagement party, wedding day, honeymoon; etc. Based on these descriptors, an operator of the system 10 may easily retrieve pre-recorded image frames corresponding to the forecast information to be included in the combined graphical information composited with time-lapse images and/or videos and/or information presentation. Alternatively, the production system 10 may be programmed to retrieve automatically via the image database 16 or video database 17 appropriate image frames corresponding to the forecast information to be included in the dynamic combined graphical information composited with time-lapse images and/or videos and/or information presentation.

At step “Generate Scaled Video Sequence from Selected Clips” 86, the selected image frames are combined and form integrated image frames for the time frame and scale previously indicated by the operator at step “Define User Information and Time Frame” 82. This may require combining several stored image frames in an appropriate order corresponding to changing information represented in the forecast information to be included in the dynamic combined graphical information composited with time-lapse images and/or videos and/or information presentation 40.

At step “Generate User Information Graphics” 88, a computer generated dynamic graphical information presentation is generated from the past, present and forecast information for the time frame to be represented in the dynamic combined graphical information composited with time-lapse images and/or videos and/or information presentation 40, in the manner described above. The resulting dynamic combined graphical information presentation and the time-scaled image frames are combined in the manner described above, at step “Combine Graphics with Video Sequence” 90, and presented, e.g., as part of a televised broadcast, in the manner described above, at step “Display Combined Video and Information Graphics” 92.

When only dynamic information needs to be updated, the user may select to approve the new information at step “Display Combined Video and User Information Graphics” 92 before it is saved to a medium or displayed.

At step “Update Selected Dynamic Information, Video and Image” 94, images and/or videos and/or information selected as being dynamic will be updated at the selected interval at step “Define User Information and Time Frame” 82.

Since other modifications and changes vary to fit particular operating requirements and environments it will be apparent to those skilled in the art that the invention is not considered limited to the example chosen for purposes of disclosure, and covers all changes and modifications that do not constitute departures from the true spirit and scope of this invention.

Having thus described the invention, what is desired to be protected by Letters Patent is presented in the subsequently appended claims.

What is claimed is:

1. A time-lapse summary social networking for a “dynamic combined graphical information composited with time-lapse images and/or videos and/or information presentation” for presenting past, present, and forecast information on a time-lapse image frames presentation, comprising:
means for providing operator input to the processor and system;
means for controlling the operation of the system;
means for keeping track of time for time and date stamp;
means for generating forecast user information from an independent forecasting model system;
means for gathering various user, friend, and news information;
means for obtaining conventional image frames or videos;
means for storing images or videos;
means for storing videos in a database for easy retrieval;
means for storing images in a database for easy retrieval;
means for displaying the dynamic combined graphical information composited with time-lapse images and/or videos and/or information presentation;
means for recording a time-lapse images and/or videos for a time frame of interest and upload to the system;
means for recording user information for the same time frame or acquire information pertaining to the selected media;
means for formatting and/or cropping user information, images and videos;
means for compositing a dynamic graphical images and/or videos and/or information presentation from the selected and scaled and formatted images and/or videos and/or information;
means for combining the image frames and/or videos and the dynamic graphical information presentation so it may be dynamically placed anywhere in the 4D light field of the image frames and/or videos to form a dynamic combined graphical information composited with time-lapse images and/or videos and/or information presentation;
means for presenting the dynamic combined graphical information composited with time-lapse images and/or videos and/or information presentation as part of a broadcast report;
means for selecting the static and dynamic user information and time frame of interest for the presentation;
means for searching and selecting static and dynamic stored image frames and/or videos and/or information that may be labeled with appropriate descriptors;
means for scaling and combining the selected image frames and/or videos and/or information to form an integrated time-lapse image frames and/or video and/or information for the time frame;
means for generating dynamic computer graphical information presentation from the selected past, present and forecast user information for the time frame to be represented in the dynamic combined graphical information composited with time-lapse images and/or videos and/or information presentation;
means for compositing the resulting dynamic graphical information presentation with the time-scaled image frames and/or videos and/or information;
means for displaying the dynamic graphic information composited with time-lapse images and/or videos and/or information presentation;
means for method for generating a dynamic combined graphical information composited with time-lapse images and/or videos and/or information presentation of past, present and forecast information as illustrated;
means for a method for generating a dynamic combined graphical information composited with time-lapse images and/or videos and/or information presentation;
means for displaying the dynamic combined graphical information composited with time-lapse images and/or videos and/or information presentation;
means for storing the programming instructions that control operation of the processor and database information;
means for storing user information in a database for easy retrieval; and
means for checking the interval for updating all the images and/or videos and/or information that were selected as dynamic.

2. The time-lapse summary social networking in accordance with claim 1, wherein said means for generating forecast user information from an independent forecasting model system comprises a forecast model, calendar, past events, present events, possible future events.

3. The time-lapse summary social networking in accordance with claim 1, wherein said means for gathering various user, friend, and news information comprises user information updates, location updates, twitter updates, instagram updates, email updates, biometric, behaviometric, goetagging, instant message updates, and public/private information updates.

4. The time-lapse summary social networking in accordance with claim 1, wherein said means for obtaining conventional image frames comprises a still camera, video camera, auto controlled video camera, auto controlled image camera, time and date stamps, digital camera, digital video camera, analog video camera, video tape camera.

5. The time-lapse summary social networking in accordance with claim 1, wherein said means for storing videos in a database for easy retrieval comprises a hard drive, database, network attached storage, solid state drive, and meta data video database.

6. The time-lapse summary social networking in accordance with claim 1, wherein said means for storing images in a database for easy retrieval comprises a hard drive, database, network attached storage, solid state drive, and meta data image database.

7. The time-lapse summary social networking in accordance with claim 1, wherein said means for storing information in a database for easy retrieval comprises a hard drive, database, network attached storage, solid state drive, and meta data information database.

8. The time-lapse summary social networking in accordance with claim 1, wherein said means for displaying the dynamic combined graphical information composited with time-lapse images and/or videos and/or information presentation comprises a display monitor, printer, fax machine, phone, instant messages, smart phone, social networking medium, interactive website, and multimedia message format output device.

9. The time-lapse summary social networking in accordance with claim 1, wherein said means for recording a time-lapse image frames for a time frame of interest and upload to the system comprises images, videos, information, video editing software, image editing software, cropping images, cropping videos, putting video and image frames together, moving image frames at time-spaced intervals, refocusing images from the reconstructed 4D light field images, refocusing image frames from the reconstructed 4D light field video and record time-lapse videos.

10. The time-lapse summary social networking in accordance with claim 1, wherein said means for recording user information for the same time frame or information pertaining to the selected media comprises wall posts, instant messages, emails, attachments, biometric, geotagging, user information databases, and news information.

11. The time-lapse summary social networking in accordance with claim 1, wherein said means for formatting and/or cropping images, videos, and user information, comprises resized images, resized videos, formatted user information, resized user information, and resized time stamps.

12. The time-lapse summary social networking in accordance with claim 1, wherein said means for generating a dynamic graphical information presentation from the selected and scaled and formatted user information comprises a dynamic animated graphical presentation, selected user information, selected news information, selected time frame, time synchronization, recorded time-lapse image frames, and conventional computer graphics compositing techniques to generate user graphics.

13. The time-lapse summary social networking in accordance with claim 1, wherein said means for combining the image frames and the dynamic graphical information presentation so the dynamic graphical information may be dynamically placed anywhere in the 4D light field of the image frames to form a dynamic combined graphical information composited with time-lapse images and/or videos and/or information in presentation that comprises a time-lapse image frames, graphical information, scaled image, cropped image, formatted image, scaled video, cropped video, formatted video, user information graphics, time-lapse image frame backgrounds, conventional compositing techniques for replacing selected image frame elements, software to digitally refocus image at different depths in the 4D light field, software to digitally refocus video at different depths in the 4D light field, and combine information graphics with image frames and/or videos.

14. The time-lapse summary social networking in accordance with claim 1, wherein said means for presenting the dynamic combined graphical information composited with time-lapse images and/or video and/or information presentation as part of a broadcast report comprises output devices, monitor, transmission on media channel, shared via social media, preview by operator, and/or display on an interactive website.

15. The time-lapse summary social networking in accordance with claim 1, wherein said means for selecting the static and dynamic information and time frame of interest for the presentation comprises static information, dynamic information, manually entered information, past user information, present user information, forecasted user information, user related information, status updates, comments, wall posts, number of friends, mood, user profile information, time and date, time frame, intervals for dynamic information updates.

16. The time-lapse summary social networking in accordance with claim 1, wherein said means for searching and selecting static and dynamic image frames that may be labeled with appropriate descriptors comprises search tools, image databases, video databases, database descriptors, static images, static videos, dynamic images, dynamic videos, image frames corresponding to the past, present and forecast information, image frames corresponding to the past, present and forecast information, intervals for dynamic images and/or videos updates, and searching image and video databases for clips corresponding to the defined information.

17. The time-lapse summary social networking in accordance with claim 1, wherein said means for compositing the selected image frames to form integrated image frames for the time frame comprises selected image frames, time frames, scaling image frames, cropping image frames, combining several stored image frames, integrating image frames and videos for the time frame, and compositing image frames from the selected image frames and/or videos.

18. The time-lapse summary social networking in accordance with claim 1, wherein said means for dynamically compositing graphical information presentation from the selected past, present and forecast information for the time frame to be represented in the dynamic combined graphical information composited with time-lapse images and/or videos and/or information presentation comprises user information, present information, past information, forecast information, scaled image-based information, cropped video-based information, scaled video-based information, cropped image-based information, and time frames.

19. The time-frame summary social networking in accordance with claim 1, wherein said means for compositing the resulting dynamic graphical information presentation and the time-scaled image frames comprises dynamic information-based graphics time-scaled image frames and compositing graphics with image frames.

20. The time-lapse summary social networking in accordance with claim 1, wherein said means for displaying the dynamic graphic information and composited in a time-lapse images and/or videos and/or information presentation comprises television broadcasts, Internet broadcasts, media broadcasts, databases, memory, metadata, descriptors, combined image frames and dynamic graphic information.

21. The time-lapse summary social networking in accordance with claim 1, wherein said means for method for compositing a dynamic combined graphical information composited with time-lapse images and/or videos and/or information presentation of past, present, and forecast information as illustrated comprises dynamic combined graphical information composited with time-lapse images and/or videos and/or information presentation.

22. The time-lapse summary social networking in accordance with claim 1, wherein said means for a method for generating a dynamic combined graphical information composited with time-lapse images and/or videos and/or information presentation comprises a method for generating dynamic combined graphical information composited with time-lapse images and/or videos and/or information presentation.

23. The time-lapse summary social networking in accordance with claim 1, wherein said means for displaying the dynamic combined graphical information composited with time-lapse images and/or videos and/or information presentation comprises conventional television broadcast systems, websites, social networking websites, media websites, database, analog storage systems and digital storage systems.

24. The time-lapse summary social networking in accordance with claim 1, wherein said means for checking the interval for updating information such as images, videos, and information that were selected as dynamic comprises dynamic past, dynamic present and dynamic forecast information, dynamic images, dynamic videos, and intervals for next updates.

25. A time-lapse summary social networking for a “dynamic combined graphical information composited with time-lapse images and/or videos and/or information” for presenting past, present, and forecast information on a time-lapse images and/or videos and/or information presentation, comprising:
input devices, keyboards, mice, and pen input devices for providing operator input to the processor and system;
control processing units, and memory processors for controlling the operation of the system;
clock, date, time, and system processor clock for keeping track of time for time and date stamp;
forecast model, calendar, past events, present events, and possible future events forecast model for generating forecast user information from an independent forecasting model system;
user information, location updates, twitter updates, instagram updates, email updates, instant message updates, biometric, geotagging, and public/private information updates for gathering various user, friend, and news information;
still cameras, video cameras, auto controlled video cameras, auto controlled image cameras, time and date stamps, digital cameras, digital video cameras, analog video cameras, and video tape cameras for obtaining conventional image frames;
flash memory, optical storage, and hard drive with capacity and ability for storing images and/or videos;
hard drives, databases, network attached storage devices, solid state drives, optical storage, and metadata video databases for storing videos and/or image frames for easy retrieval;
hard drives, databases, network attached storage devices, solid state drives, optical storage, and metadata image databases for storing images for easy retrieval;
display monitors, printers, fax machines, phones, instant messages, smart phones, social networking websites, and multimedia message output devices, for displaying the dynamic combined graphical information composited with time-lapse images and/or videos and/or information presentation;
images, videos, image editing software, video editing software, cropping images, cropping videos, compositing image frames at time-spaced intervals, refocusing image frames from the reconstructed 4D light field images, refocusing videos from the reconstructed 4D light field videos, and time-lapse image frames for recording image frames for a time frame of interest and upload or save to the system;
wall posts, instant messages, emails, attachments, user information databases, and user news information for recording information for the same time frame or information pertaining to the selected information;
resized images, resized videos, resized information, resized time stamp, scaled images, scaled videos, scaled information, formatted images, formatted videos, formatted information;
dynamic animated graphical information presentation, selected user information, selected time frame, time synchronization, recorded time-lapse image frames, conventional computer graphics compositing techniques for generating a dynamic combined graphical information presentation from the selected, scaled, and formatted user information;
time-lapse image frames, graphical information, scaled image frames and/or videos, cropped image frames and/or videos, formatted information, graphical user information, time-lapse image frames background, conventional compositing techniques for replacing selected image elements, software to digitally refocus image frames at different depths, and software to digitally refocus videos at different depths for combining the image frames and/or videos and the dynamic graphical information presentation so it may be dynamically placed anywhere in the 4D light field of the image frames and/or videos to form a dynamic combined graphical information composited with time-lapse images and/or videos and/or information presentation;
output devices, monitors, transmitted on media channels, shared via social media channels, preview by operators, and displayed on websites for presenting the dynamic combined graphical information composited with time-lapse images and/or videos and/or information presentation as part of broadcast reports;
static information, dynamic information, manually entered information, past user information, present user information, forecasted user information, status updates, wall posts, number of friends, mood, user profile information, time and date information, time frame, interval for dynamic information updates define user information, time frame for selecting the static and dynamic user information, and time frame of interest for the presentation;
search tools, image databases, video databases, database metadata descriptors, static images and/or videos, dynamic images and/or videos, image frames corresponding to the past, present and forecast information, videos corresponding to the past, present and forecast information, intervals for dynamic image frames and/or information updates, search tools for images and/or videos and/or information databases for clips corresponding to the defined information, and search tools for searching and selecting static and/or dynamic stored image frames and/or videos that may be labeled with appropriate descriptors;
selected videos, selected image frames, time frame, combining several stored image frames and/or videos, and integrated image frames and/or videos for the time frame to generate scaled image frames and videos from selected clips for scaling and combining the selected image frames and videos to form integrated image frames and videos for the time frame;
user information, present information, past information, forecast information, news information, scaled video-based user information, cropped image-based user information, scaled image-based user information, and time frames for selecting user information graphics for generating dynamic computer graphical information presentations from the selected past, present and forecast user information for the time frame to be represented in the dynamic combined graphical information composited with time-lapse images and/or videos and/or information presentation;
dynamic information-based graphics and time-scaled image frames and/or videos that combine information-based graphics with image frames and/or videos for the resulting dynamic graphical information presentation composited with the time-scaled image frames and/or videos and/or information;
television broadcasts, Internet broadcasts, and media broadcasts for displaying the combined dynamic graphic information composited with the image frames and/or videos and/or information presentation;
a combined dynamic graphical information composited with time-lapse images and/or videos and/or information presentation of past information for generating a combined dynamic graphical information composited with time-lapse images and/or videos and/or information presentation of past, present and forecast information as illustrated;
a method for generating a combined dynamic graphical information composited with time-lapse images and/or videos and/or information presentation by combining dynamic graphical information composited with time-lapse images and/or videos and/or information presentation;
a conventional television broadcast system, websites, social networking websites, media websites, databases, analog storage devices and/or digital storage devices, and broadcast systems for displaying the combined dynamic graphical information composited with time-lapse images and/or videos and/or information presentation;
programming instructions, random access memory, saving images in databases, saving videos in a databases, saving user information in databases and saving the combined dynamic graphical information composited with time-lapse presentation memory, and saving the programming instructions that control operation of the processor and database information;
status updates, metadata, wall posts, public/private information updates, hard drives, solid state drives, network attached storage devices, user information databases for storing information in a database for easy retrieval; and
dynamic past, dynamic present and dynamic forecast information, dynamic images, dynamic videos, and the time intervals for updating all the images, videos, and information that were selected as dynamic.

26. A time-lapse summary social networking for a “time-lapse summary social networking” for presenting past, present, and forecast data on a time-lapse images and/or videos and/or information presentation, comprising:
input devices, keyboards, mice, and pen input devices for providing operator input to the processor and system;
a control processing unit, memory processor, for controlling the operation of the system;
a clock, date, time, and system processor clock for keeping track of time for time and date stamp;
a forecast model, calendar, past events, present events, and possible future events forecast model for generating forecast information from an independent forecasting model system;
status updates, automatic status updates, user provided status updates, formatted text, mood displays, graphical mood displays, user location updates, geotagging, biometric, time and date stamps, dynamic updates, static updates, “like” buttons showing other users approval, comments for status updates, “unlike” button showing other users disapproval, feeling, moods, location updates, and action status updates for updating a users profile with dynamic information;
user profile spaces, automatic updates, user provided updates, 3rd party provided updates, approval and disapproval buttons, comments, messages, time and date stamps, attachments, news feed, profile changes, people connection updates, and wall posts, for displaying on the profile space that is visible to anyone with the access to see his or her profile;
user information, location updates, Twitter updates, Instagram updates, email updates, instant message updates, and public/private information updates for gathering various user, friend, and news information;
still cameras, video cameras, auto controlled video cameras, auto controlled image cameras, time and date stamps, digital image cameras, digital video cameras, analog video cameras, and video tape cameras for obtaining conventional image frames with audio;
flash memory and hard drive image and/or storage, for storing image and/or video and/or information;
hard drives, databases, network attached storage devices, solid state drives, metadata video database for storing videos in a database for easy retrieval;
hard drives, database, network attached storage devices, solid state drives, metadata image databases, for storing images in a database for easy retrieval;
display monitors, printers, fax machines, phones, instant messages, smart phones, social networking mediums, website, interactive website, and multimedia message format output devices for displaying the dynamic combined graphical information composited with time-lapse images and/or videos and/or information presentation;
analog clock, digital clock, opaque clock display, formatted time and date text, real time temporal context, and time of day for displaying time and date for the time-lapse images and/or videos and/or information presentation;
image frames, videos, and information for displaying the image frame background;
number of friends, graphical friend representation, and dynamically updated social networking friends for displaying the number of social networking friends during time frame represented by the combined dynamic graphical and time-lapse images and/or videos and/or information presentation;
an up indicator, down indicator, plus indicator, negative indicator, equal indicator, direction indicator, and dynamically updated indicator for number of friends for indicating the changing number of friends during the time frame represented by the time-lapse images and/or videos and/or information presentation;
graphical mood displays, formatted text mood displays, dial type mood displays, dynamically animated to move left or right and/or dynamically animated to move up or down, corresponds to changes in mood, mark for high and/or low moods reached during the time frame, and other dynamic graphical mood display for displaying a graphically represented mood in the box for the time frame represented by the dynamic combined graphical information composited with time-lapse images and/or videos and/or information presentation;
formatted text, scrolling formatted text, dynamic updates, and increasing number and decreasing number indicate dynamically changing wall posts and indicate dynamically changing number of wall post for displaying the number of wall posts in the graphically represented information;
images, videos, video compositing software, image editing software, cropping image frames, cropping videos, images, image frames, image frames at time spaced intervals, refocusing image from the reconstructed 4D light field image frames, refocusing image from the reconstructed 4D light field videos, and record time-lapse images and/or videos and/or information for recording a time-lapse images and/or videos and/or information presentation for a time frame of interest and upload to the system;
wall posts, instant messages, emails, attachments, user information databases, and news information for recording user related information for the same time frame or information pertaining to the selected media;
resize videos, resize images, format user information, resize user information, resize time stamp text, scale image frames, scale videos, scale user information for graphical information presentation, images and videos;
dynamic animated graphical presentation, selected user information, selected time frame, time synchronization, recorded time-lapse images and/or videos and/or information, conventional computer graphics generation techniques for generating a dynamic combined graphical information presentation from the selected and scaled and formatted user information;
time-lapse images, graphical information, scaled image frames, cropped videos, formatted information, user graphics, time-lapse image frames for background, time-lapse videos for background, time-lapse information for background, conventional compositing techniques for replacing selected image elements, software to digitally refocus images at different depths, and software to digitally refocus video at different depths for dynamically combining the image frames and/or videos and the dynamic graphical information presentation so it may be placed anywhere in the 4D light field of the image frames or videos to form a combined graphical information composited with time-lapse images and/or videos and/or information presentation;
output devices, monitors, transmitted on media channels, shared via social media, preview by operators, displayed on websites for presenting the dynamic combined graphical information composited with time-lapse images and/or videos and/or information presentation as part of a broadcast report;
static information, dynamic information, manually entered information, past user information, present user information, forecasted information, status updates, comments, wall posts, number of friends, mood, user profile information, time and date stamps, time frame, interval for dynamic information updates define user information and time frame for selecting the static and dynamic user information and time frame of interest for the presentation;
search tools, image databases, video databases, database descriptors, static image frames and/or videos, image frames and/or videos, image frames and/or videos corresponding to the past, present and forecast information, information corresponding to the past, present and forecast information, intervals for dynamic images and/or video and/or information updates for searching and selecting static and dynamic stored images and/or video and/or information that may be labeled with appropriate descriptors;
selected videos, selected image frames, time frame, combining several stored image frames and/or videos and/or information, and integrated image frames and/or videos and/or information for the time frame to generate scaled image frames and/or videos and/or information from selected clips for scaling and combining the selected image frames and/or videos and/or information to form integrated image frames and/or videos and/or information sequence for the time frame;
user information, present information, past information, forecast information, scaled video-based user information, cropped image-based user information, scaled image-based user information, and time frame user information graphics for generating dynamic computer graphical information presentation from the selected past, present and forecast user information for the time frame to be represented in the dynamic combined graphical information composited with time-lapse images and/or videos and/or information presentation;
dynamic information-based graphics, and time-scaled information for dynamic combined graphics with image frames and/or videos and/or information for combining the resulting dynamic graphical information presentation;
television broadcasts, Internet broadcasts, media broadcasts, websites, interactive websites for displaying the dynamic combined graphic information and images and/or videos and/or information presentation;
a dynamic combined graphical information and images and/or videos and/or information presentation of past information for generating a dynamic combined graphical information composited with time-lapse images and/or videos and/or information presentation of past information is illustrated;
a method for generating a dynamic combined graphical information and images and/or videos and/or information presentation for generating a dynamic combined graphical information and images and/or videos and/or information presentation;
conventional television broadcast systems, websites, social networking websites, media websites, databases, and analog and/or digital storage broadcast systems for displaying the dynamic combined graphical information and images and/or videos and/or information presentations;
memory, programming instructions, random access memory, and databases for storing the programming instructions that control the operation of the processor and database information;
a dot, color indicator, mood indicator, and feelings indicator with indicating marks for the level of mood or type of feelings;
status updates, metadata, wall posts, public/private information updates, hard drives, solid state drives, network attached storage devices, and user information databases for storing user information in a database for easy retrieval; [symbol]
